(19) United States
(12) Patent Application Publication
(10) Pub. No.: US 2016/0253171 A1
(43) Pub. Date: Sep. 1, 2016

(54) APPLICATION DEVELOPMENT SYSTEM WITH NATIVE FEATURE ENGINE

(71) Applicants: Yan ZANG, Singapore (SG); Sheng YAO, Singapore (SG)

(72) Inventors: Yan ZANG, Singapore (SG); Sheng YAO, Singapore (SG)

(21) Appl. No.: 14/631,871

(22) Filed: Feb. 26, 2015

(51) Int. Cl. G06F 9/44; G06F 3/0484; H04L 29/08

(52) U.S. Cl. CPC G06F 8/70; H04L 67/02; H04L 67/2809; G06F 3/0484

(57) ABSTRACT

A framework for developing applications is described herein. The framework may be a web integrated development environment (IDE) with a preview function via a browser. The IDE includes a native feature runtime engine with plugin application programming interfaces (APIs), such as Cordova APIs. Browser implementations of the plugin are also provided. The browser implementations enable a hybrid application to be previewed in the browser and access native functions without crashing the IDE.

### TECHNICAL FIELD

The present disclosure relates generally to a framework for developing applications (Apps).

### BACKGROUND

Apps are developed for a wide variety of purposes. One type of App is web-based App (web App). A web App, for example, includes web application code that resides on a server. The web App is accessed using a browser on an end-user device. An advantage of web Apps is that they can be maintained and updated without distributing and installing software on local devices as well as inherent support for cross-platform compatibility. To develop a web App, a web integrated development environment (IDE) may be employed.

Conventional web Apps generally cannot access local resources, unlike a native App. For example, the web browser prevents access by the web App to native features of a mobile device. In other words, web Apps are not mobile enabled. Access to native features may be provided through hybrid Apps. However, conventional IDEs are incapable of previewing native features of a hybrid App through the IDE browser. The inability of IDEs to preview native features of a hybrid App leads to development inefficiencies.

The present disclosure relates to an IDE capable of previewing native features of a hybrid App using the browser.

### SUMMARY

A framework for developing applications is described herein. In one embodiment, a computer-implemented method for developing an application is disclosed. The method includes developing a project application using a web integrated development environment (IDE) with a preview function via a browser. The project application includes a hybrid application using native features of a mobile device. The method includes selecting the preview function for previewing the project application in the IDE. In response to the selecting the preview function, a native feature runtime engine is invoked. The native feature runtime engine includes plugin application programming interfaces (APIs) of the mobile device. The project application is run in the browser. The project application has access to local resources through browser implementations of plugin APIs provided by the native feature runtime engine.

In another implementation, an IDE for developing an application is described. The IDE includes a preview module for previewing a project application in a browser on an end-user device running the IDE. The IDE also includes a native feature runtime engine. The native feature runtime engine includes an API unit having plugin APIs of a mobile device. The native feature runtime engine also includes an implementation unit having browser implementations of the plugin APIs in JavaScript. The browser implementations enable the application to be previewed in the IDE running in the browser. The native feature runtime engine further includes a proxy unit for selecting a browser implementation of a called plugin API used by the project application when previewing the project application in the IDE using the browser. The native feature runtime engine is invoked when the preview module is initiated to preview the project application.

In yet another implementation, a computer usable medium having a computer readable program code tangibly embodied therein, and which is adapted to be executed by a processor to implement a method for developing an application which includes developing a project application using a web IDE with a preview function via a browser is described. The application includes a hybrid application using native features of a mobile device. A preview function for previewing the application is selected in the IDE. In response to the selecting the preview function, a native feature runtime engine is invoked. The native feature runtime engine includes plugin APIs of the mobile device. The project application is run in the browser which has access to local resources through browser implementation of plugin APIs provided by the native feature runtime engine.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 shows an implementation of an environment;

FIG. 2 shows a simplified block diagram of an embodiment of an App development system;

FIG. 3 shows a simplified block diagram of an embodiment of a web IDE;

FIG. 4 shows a simplified block diagram of an exemplary embodiment of a preview window with context in a web IDE;

FIG. 5 shows a simplified process flow for designing an App;

FIG. 6 shows a screen shot of an IDE with a native feature runtime engine; and

FIG. 7 shows a preview page of an IDE with a native feature runtime engine.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

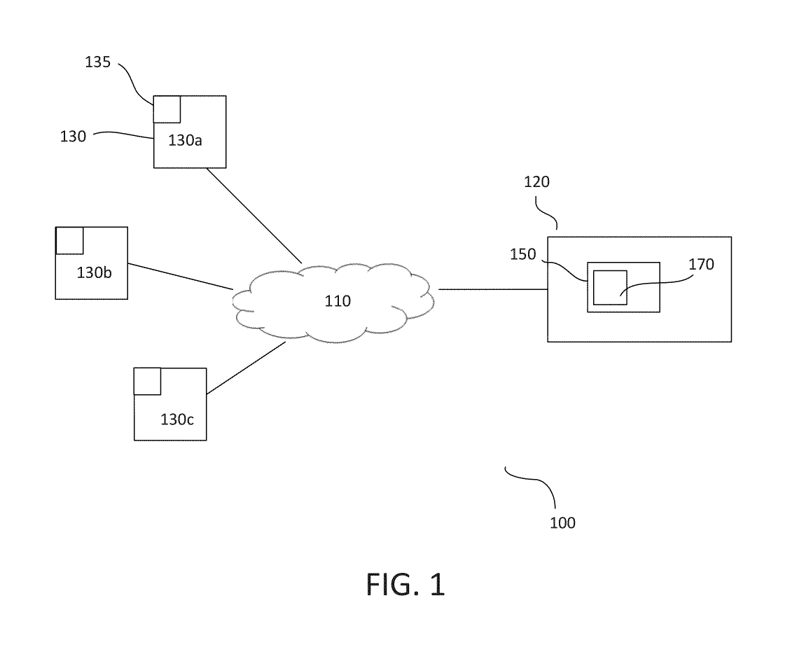

FIG. 1 shows a simplified diagram of an exemplary environment or architecture 100. The environment 100 may have a distributed architecture, such as a client-server architecture. The environment, in one implementation, includes a communication network 110. The communication network, for example, may be the World Wide Web (WWW or Web). Other types of communication networks or combination of networks may also be useful.

The environment includes a server 120. A server may be a computer with a memory and a processor. Various types of computers may be employed for the server. For example, the computer may be a mainframe, a workstation, as well as other types of processing devices. The memory of a computer may include any memory or database module. The memory may be volatile or non-volatile types of non-transitory computer-readable media, such as magnetic media, optical media, random access memory (RAM), read-only memory (ROM), removable media, or any other suitable local or remote memory component.

The server 120, for example, may include a plurality of interconnected servers. For example, the servers are interconnected by a communication network. The communication network may be an internet, an intranet, a local area network (LAN), a wide area network (WAN) or a combination thereof. The servers may be located in a single or multiple locations. The interconnected servers may be collectively referred to as a server.

The server 120 is configured to store and process resources requested by client devices 130. As shown, the environment includes client devices 130a-130c. It is understood that the environment may include other number of client devices. A client device may be a local computing device with, for example, a local memory and a processor. The memory may be volatile or non-volatile types of non-transitory computer-readable media, such as magnetic media, optical media, random access memory (RAM), read-only memory (ROM), removable media, or any other suitable local or remote memory component. Various types of processing devices may serve as the client device. For example, the client device may be a PC, a tablet PC, a workstation, a network computer, or a mobile computing device, such as a laptop, a tab or a smart phone. Other types of processing devices may also be used. It is understood that client devices may be different types of client devices.

The environment of the client device may be referred to as a local or native environment. A client or end-user and client device may be used interchangeably. For example, when referring to an end-user, it is understood that the end-user connects to the communication network using a client device. The client device may be referred to as the client side while the server may be referred to as the server side. It is understood that client devices need not be of the same type. For example, some client devices may be mobile devices running on different types of platforms, such as iOS or Android, while other client devices may be desktop or laptop computers.

In one implementation, the local environment of the client device includes a user agent 135. The user agent, for example, may be a web browser. The browser facilitates communication with the server. For example, the browser initiates communication to a web server by making a request for a specific resource using, for example, a Hypertext Transfer Protocol (HTTP) and the server responds with the content of that resource. Communication with the server, for example, may be through internet connection. The internet connection may be using a mobile telecommunication network, such as a 4G network. Other types of connections to the server may also be useful. An end-user may access the server by, for example, having a user account.

In other implementations, the environment 100 may be a cloud computing environment. In such cases, the interconnected servers 120 form a cloud. The cloud, for example, hosts and processes resources, such as applications and data, as well as other resources. Different servers may be used to store or process different resources. Such hosting and processing may be considered as cloud services. Various types of cloud services may be provided. The cloud services may be provided in a public, private or hybrid network. The cloud services may be provided by a cloud service provider. For example, the cloud services may be SAP HANA Cloud Platform provided by SAP SE. Other types of clouds and cloud providers may also be useful. A client device 130 accesses resources on the cloud using, for example, a browser 135. Other configurations of the environment may also be useful.

The environment 100 includes an application (App) development system 150. The App development system 150 is a software development tool for developing Apps. The development tool, for example, is used to develop web Apps. In one implementation, the development tool is an integrated development environment (IDE). The IDE may be a wizard-based IDE. For example, the IDE includes wizards to guide the developer in developing Apps. In one implementation, the IDE is a web-based or web IDE residing in the server 120. In some implementations, the IDE resides on the cloud. The web IDE is accessed by a web browser 135 on a client device 130. For example, a developer or end-user may log on to the cloud, accessing the IDE from the web browser of a client device. The IDE, for example, may be a SAP Web IDE from SAP SE. Other types or configurations of IDEs may also be useful. Apps under development may be stored in the server.

In one implementation, the App development system 150 includes a native feature runtime engine 170. The native feature runtime engine includes a set of application program interfaces (APIs) for accessing native features or functions of a mobile device. For example, the runtime engine includes plugin APIs for accessing native functions of the mobile device. The native feature runtime engine is built without native code. For example, the runtime engine is built with JavaScript (JS). JavaScript is common to all mobile platforms and desktop browsers. Other programming languages which are common to browsers may also be useful. In one implementation, the runtime engine includes a Cordova runtime engine. For example, the runtime engine includes Cordova APIs for accessing native features. The Cordova runtime engine may also include other types of plugin APIs for accessing native features. For example, the runtime engine may include Cordova APIs as well as other types of APIs, such as Kapsel APIs.

The runtime engine includes a browser-targeted implementation for plugins of the native features. In one implementation, the runtime engine includes a browser-targeted implementation for each plugin of the native features. The runtime engine enables a hybrid App to be previewed in the browser. For example, when running a hybrid App in the IDE using the browser, such as previewing the App using a preview module, execution of browser-targeted implementations of the plugin APIs by the App avoids crashing the IDE. The hybrid App can run in the browser, with APIs exiting gracefully without a crash. API context can be dynamically injected into the preview module, making the APIs available to the App being previewed. For example, targeted API context, such as Cordova context, is injected into the preview module when the preview module is invoked. In addition, user interface (UI) settings of the IDE may be provided to enable users, such as App developers, to specify various parameters for different API plugins. For example, the settings may enable a user to specify the current location for a geolocation plugin using Google Map. The settings enable users to easily preview native features of a mobile device.

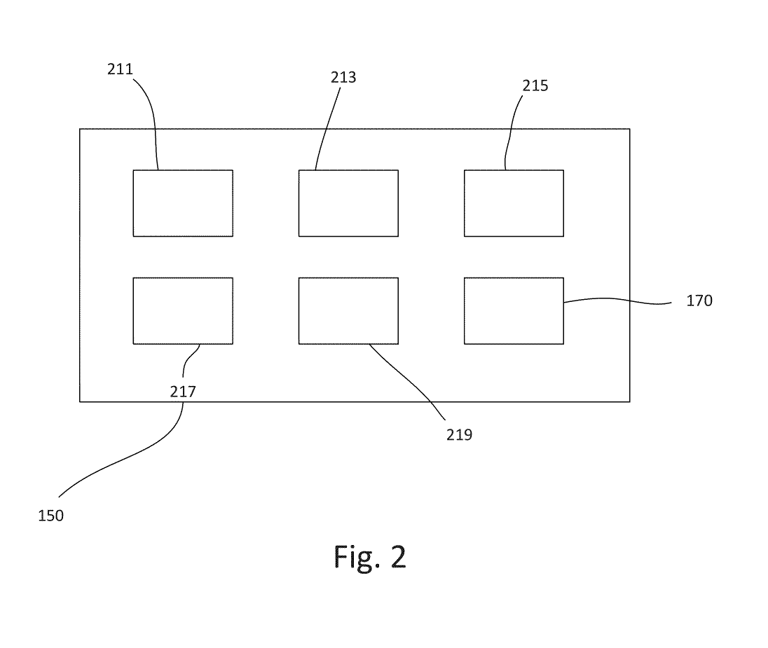

FIG. 2 shows a simplified block diagram of an embodiment of an App development system 150. As shown, the App development system includes various modules for developing an App. In one implementation, the App development system includes a UI module 211, a resource module 213, a code module 215, a preview module 217, a native feature runtime engine 170 and a deployment module 219. Providing different or additional modules may also be useful.

The UI module 211 may be a graphical UI (GUI) module. The UI module enables a user to navigate the IDE. For example, the UI may include a menu bar with commands or functions that a user can select. The commands and functions facilitate in the process of creating, testing and deploying the App. In one implementation, the UI may be based on SAP UI5. Other types of UIs may also be useful.

The resource module 213 includes resources for creating or developing an App. For example, the resource module includes various templates for different types of Apps. The resource module may include templates, such as Kapsel App templates, Fiori Templates and plugins, vertical business to enterprise (B2E) App templates and business to customer (B2C) App templates. Providing other types of templates may also be useful.

The resource module may include other types of resources for developing Apps. Such resources may include design resources, such as layout command resources. For example, mobile controls, mobile UI components and context model designers may be included in the resource module. A context model designer may be used to design reasoning model for a context-aware application. Context model designers, such as those provided in SAP Hana Studio IDE may be employed. Other types of resources may also be included.

The code module 215 facilitates coding for the App. For example, a user, such as a designer or developer of Apps, may employ the code module to generate codes for the App. In one implementation, the code module includes a code editor for manual coding as well as auto-coding capabilities, such as coders, for completing codes or adding code snippets. For example, coders for completing native feature plugins, such as drag and drop Kapsel and Cordova code snippets and drag and drop context code snippets, may be provided. Other coders may also be included in the coding module. The generated codes may be modified using the code editor.

The preview module 217 facilitates previewing an App that has been developed or is under development. A preview button, such as a run button may be provided in the UI to preview an App. Other techniques for previewing the App may also be useful.

As for the native feature runtime engine 170, it includes a set of APIs for accessing native features or functions of a mobile device. The native feature runtime engine may be built with code that includes a common platform code. For example, the code includes code common to mobile platforms and desktop browsers. For example, the runtime engine is built with JS. In one implementation, the runtime engine includes a Cordova runtime engine. For example, the runtime engine includes Cordova APIs for native features. The Cordova runtime engine may also include other types of APIs for native features. For example, the runtime engine may include Cordova APIs as well as other types of APIs, such as Kapsel APIs. The runtime engine includes browser-targeted implementations for each plugin of native features. The browser-targeted implementations are built with, for example, JS.

The runtime engine enables execution of plugin APIs by an App during, for example, previewing using the preview module, to avoid crashing the IDE. API context can be dynamically injected into the preview module, making the APIs available to the App being previewed. Furthermore, parameters may be specified for different plugins through UI settings.

The deployment module 219 includes functions to facilitate deployment of the App. The App may be deployed to SMP and mobile device, in the case of a hybrid app. The SMP is a mobile server from SAP which manages the life cycle of mobile applications on the devices. For example, when the deployment command is selected, the deployment module configures the App, simplifies settings, builds the App and deploys it. In the case of a web App, it may be deployed to a web server. The IDE may include other modules or different modules.

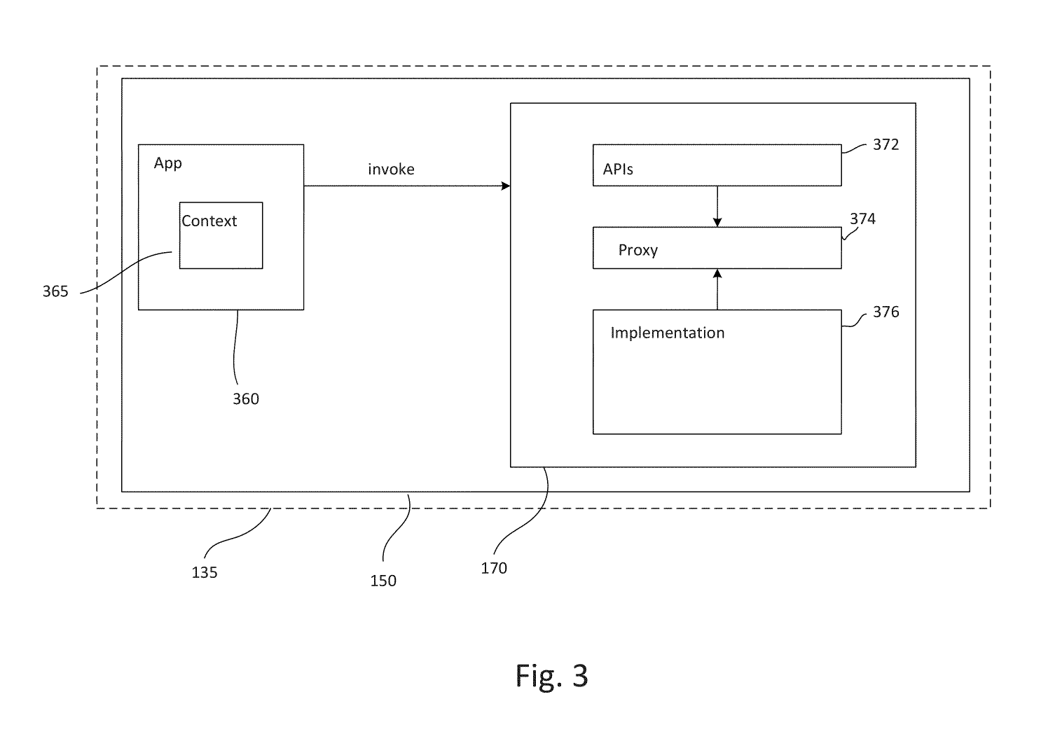

FIG. 3 shows a simplified architecture of an embodiment of a web IDE 150. As shown, the IDE runs in a browser 135 of an end-user device. The end-user device, for example, may be a desktop or laptop computer. Other types of end-user devices may also be useful. As shown, a user develops an App 360 using the IDE. The App, in one implementation, is a hybrid App using native features. A user may preview the App using, for example, the preview module of the IDE. To preview the App, the user may select the preview option. For example, a user may select a run button on the IDE's UI, which activates the preview function. Other techniques for activating the preview function may also be useful.

When the preview function is activated, the preview module runs the App in the browser. Activating the preview function, in the case of a hybrid App, also invokes a native feature runtime engine 170 for previewing the hybrid App. In the case of a web App, the native feature runtime engine need not be invoked. The native feature runtime engine 170, as shown, includes an API unit 372, a proxy unit 374 and an implementation unit 376. Providing a native feature runtime engine with other units may also be useful. The native feature runtime engine serves as a container, such as a Cordova container, for running the hybrid App in the browser.

The API unit includes a set of plugin APIs for accessing native features or functions of a mobile device. The APIs are built on a programming language common to mobile platforms and desktop browsers. For example, the plugin APIs are JS APIs. In one implementation, the APIs include Cordova APIs. Other types of APIs, such as Kapsel APIs, may also be useful.

As for the implementation unit 376, it includes browser-targeted implementation for the plugin APIs in the API unit. For example, the implementation unit includes browser-targeted implementations for each plugin API in the API unit. A plugin, such as a Cordova or Kapsel plugin, exposes an API function. A plugin needs different implementations for different kinds of devices. For example, depending on the platform, different implementations are needed. In the case of an Android platform, a Java implementation of the plugin is needed while an Objective-C implementation is needed for an iOS device. In one embodiment, the implementation unit includes a common platform plugin implementation. In one embodiment, the common platform plugin implementation includes a JS implementation of the plugin. The common platform plugin implementation can be run on the browser. Other implementations may also be provided for other targeted platforms.

The proxy unit provides implementations targeted to different platforms for the plugins. For example, Java implementations are provided for running the hybrid App on an Android device, Objective-C implementations are provided for running the hybrid App on an iOS device while the JS implementations are provided for previewing the App on the browser. Settings in the UI enable the user to change the parameters of the plugins.

During previewing of the hybrid App, common platform implementations of the plugins are provided from the implementation unit. For example, when native features are used by the app, the proxy unit invokes the JS implementations of the plugins. A proxy function may have the following signature:

function xAPI(success, fail, args)

where

xAPI is an API which is called,

args is the parameter where arguments are passed, and

return values are sent back through success or fail call back functions.

The proxy function, for example, is an asynchronous function and returns immediately. Context 365 may be dynamically injected into the preview environment, making the APIs available for previewing. A UI setting may be provided to indicate whether context is injected during previewing. For example, if this setting is enabled, activating previewing injects context automatically.

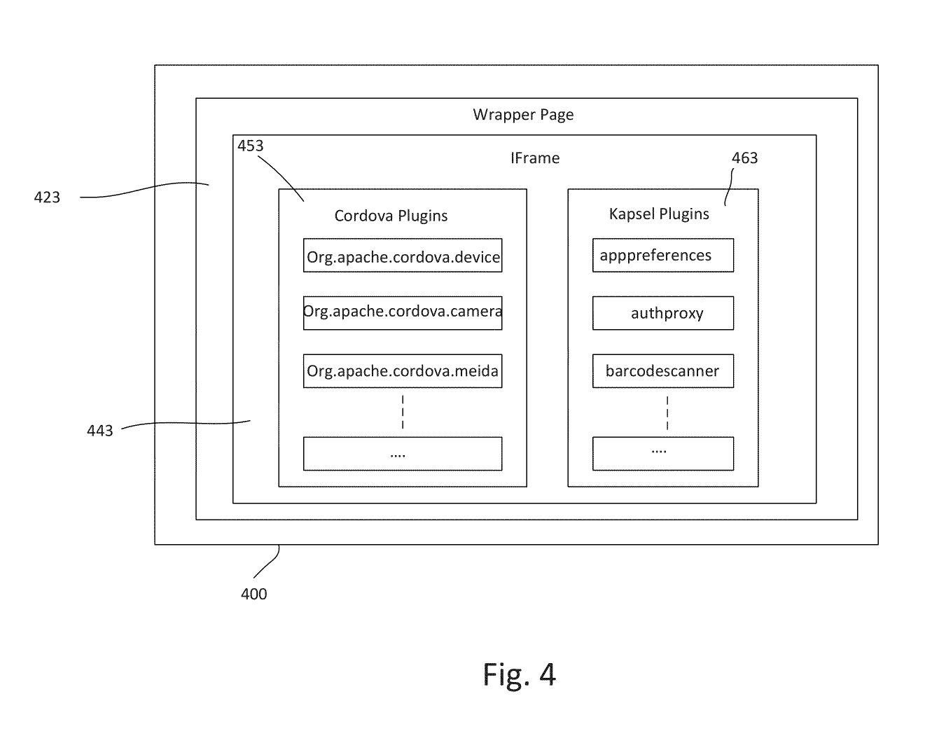

FIG. 4 shows a simplified block diagram of an exemplary embodiment of a preview window 400 with context in a web IDE. The preview window includes a wrapper page or layer 423. The wrapper layer includes, for example, form factor definition of the preview window. Within the wrapper layer is an IFrame 443. The IFrame includes APIs for accessing native features of a device for previewing the App. In one implementation, the IFrame includes a set of Cordova plugins 453 and a set of Kapsel plugins 463. Providing other types of plugins or APIs may also be useful.

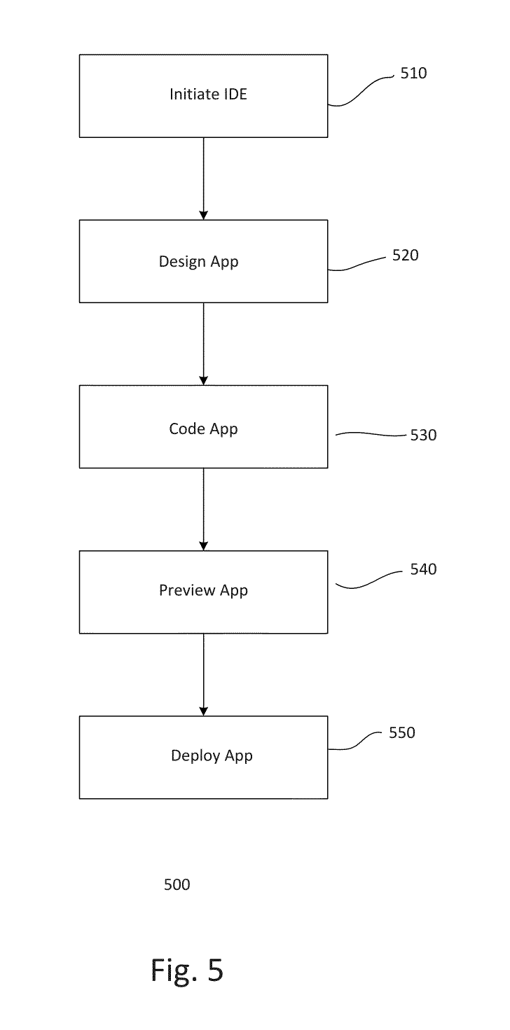

FIG. 5 shows a simplified process flow 500 for designing an App. As shown, a user may initiate the App development system on the cloud at step 510. For example, a user may, through the browser of the end-user device, initiate the App development system for creating an App, such as a hybrid App. At step 520, the user designs the App using the IDE. The App is coded at step 530. The user may preview the App at step 540. For example, the user may select the preview command in the browser. This causes the preview module to invoke the native feature engine. The App is previewed in the browser using plugin APIs from the native feature runtime engine. After the App is completed, the App is deployed at step 550. For example, the deployment command is selected, causing the App to be deployed.

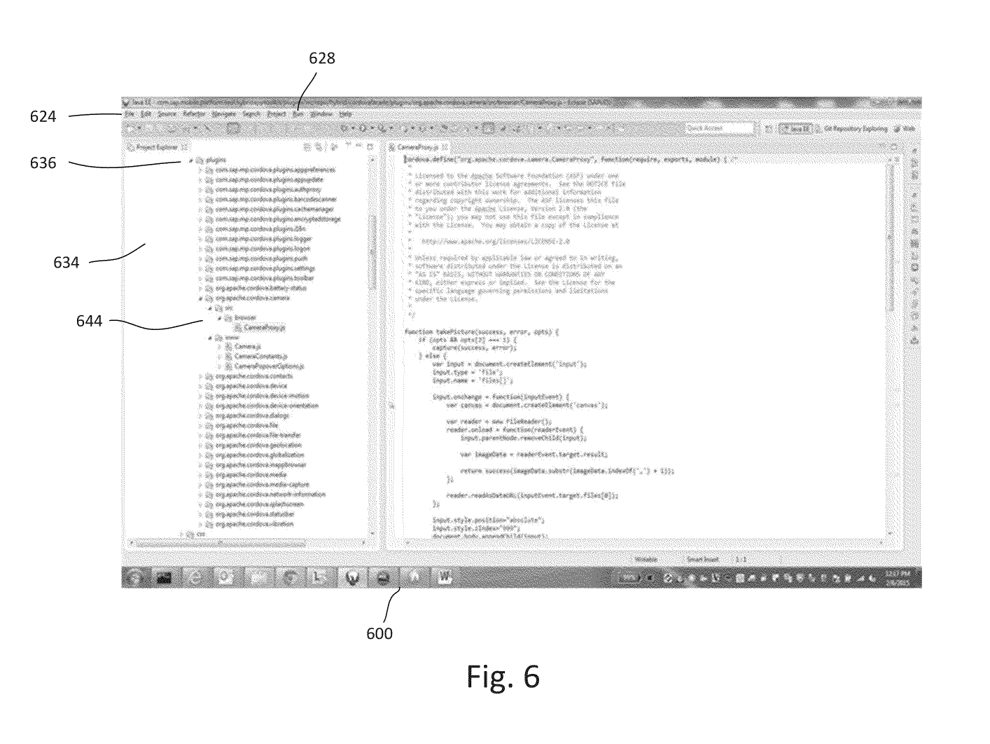

FIG. 6 shows a screen shot of a UI 600 of an IDE with a native feature runtime engine. The UI for example, is based on SAP UI5. Other types of UIs may also be useful. In one implementation, the UI is part of a SAP Web IDE. Other configurations may also be useful. The UI includes a menu bar 624 for navigating the IDE. As shown, the menu includes a run item 628 for activating the preview function of the IDE. In addition, the UI includes a workspace directory panel 634 that displays the directory structure of a workspace which contains various projects. The workspace, for example, resides on the cloud. Projects, for example, are App projects.

As shown, the directory structure includes a plugin folder 636. The plugin folder, for example, corresponds to the native feature runtime engine of the IDE. The plugin folder contains individual API folders for individual APIs of native features. In one implementation, the native feature runtime engine includes a Cordova engine, containing Cordova APIs. An API folder includes a src folder and a www folder. The www folder includes the standard plugin API exposed to the user application. As for the src folder, it may include various implementations for different platforms. As shown, the src folder includes a subfolder 644 for the browser implementation. The src folder may include subfolders for other implementations for different targeted platforms. For example, the src folder may include a subfolder for the Android implementation and a subfolder for the iOS implementation. Providing other subfolders for other implementations may also be useful.

When previewing a hybrid App, the hybrid App may use a native feature. The App invokes a plugin API in the www folder corresponding to the native feature used. The plugin function invokes the proxy function. The proxy function looks up the src folder and finds the corresponding implementation for this action and invokes it. For example, the JS implementation is invoked, enabling the App to run in the browser without crashing the IDE.

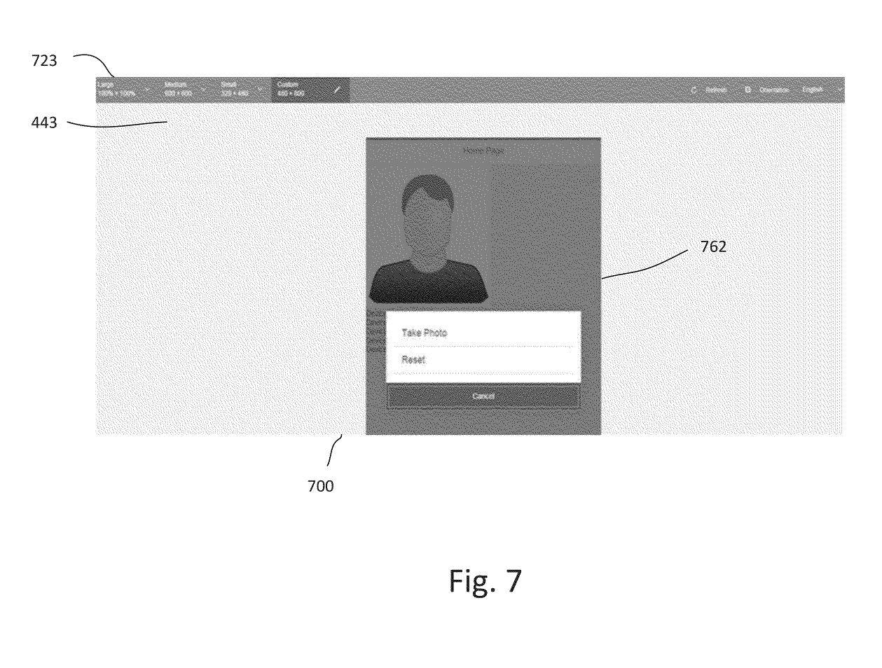

FIG. 7 shows a preview page 700 of an IDE with a native feature runtime engine in a browser. As shown, the preview page includes a tool bar 723 at the top of the page. The tool bar corresponds to the wrapper layer. The tool bar enables a user to select the form factor as well as orientation of a preview window 762. Providing other functions in the tool bar may also be useful.

The remaining portion of the page corresponds to an IFrame 443. Within the IFrame is the preview window 762. As shown, the preview window is previewing an App (e.g., project App) using a camera function of the mobile device. For example, the camera API is provided by the native feature runtime engine. In one implementation, the camera API is a Cordova camera API. A user may select to take a photo or to reset the preview page. If the user selects to take the photo, the camera takes a photo and displays it in the preview window. For example, the device which runs the IDE may include a camera which is activated by the API. Resetting the page results in the page being refreshed.

As described, the application development system with a native feature runtime engine may be embodied as an application. For example, the application development system may be embodied as a software application. The different components of the system may be separate software applications configured to operate or interact with each other, whether on the cloud or on the end-user devices. The source code of the applications may be compiled to create an executable code. The codes, for example, may be stored in a storage medium, such as one or more storage disks or in memory of a server and/or end-user devices. Other types of storage media may also be useful.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for developing an application, comprising:
developing a project application using a web integrated development environment (IDE) with a preview function via a browser, wherein the project application includes a hybrid application using native features of a mobile device;
selecting the preview function for previewing the application in the IDE; and
in response to the selecting the preview function,
invoking a native feature runtime engine, wherein the native feature runtime engine comprises plugin application programming interfaces (APIs) of the mobile device, and
running the project application in the browser, wherein the project application has access to local resources through browser implementations of plugin APIs provided by the native feature runtime engine.

2. The computer-implemented method of claim 1 wherein the runtime engine comprises:
an API unit including the plugin APIs of the mobile device; and
an implementation unit including the browser implementations of the plugin APIs, wherein the browser implementations are implemented in a common platform language for browsers, wherein the browser implementations enable the project application to be previewed in the IDE running in the browser.

3. The computer-implemented method of claim 2 wherein the runtime engine further comprises a proxy unit for selecting a selected browser implementation of a called plugin API used by the project application when previewing the project App in the IDE using the browser.

4. The computer-implemented method of claim 3 comprising dynamically injecting context to the selected browser implementation of the called plugin API if context injection is selected by a user when previewing the project application.

5. The computer-implemented method of claim 1 wherein the runtime engine comprises:
an API unit including the plugin APIs of the mobile device; and
an implementation unit including the browser implementations of the plugin APIs, wherein the browser implementations are implemented in JavaScript, wherein the browser implementations enable the project application to be previewed in the IDE running in the browser.

6. The computer-implemented method of claim 5 wherein the runtime engine further comprises a proxy unit for selecting a selected browser implementation of a called plugin API used by the project application when previewing the project application in the IDE using the browser.

7. The computer-implemented method of claim 6 wherein the runtime engine further comprises dynamically injecting context to the selected browser implementation of the called plugin API if a context injection setting in an IDE user interface (UI) is selected by a user when previewing the project application.

8. The computer-implemented method of claim 1 wherein the plugin APIs comprises Cordova APIs.

9. The computer-implemented method of claim 8 wherein the plugin APIs further comprises Kapsel APIs.

10. The computer-implemented method of claim 1 wherein the native feature runtime engine serves as a container for previewing the project application in the IDE.

11. The computer-implemented method of claim 1 comprising providing a preview page when the preview function is selected, the preview page comprises:
a wrapper page; and
an IFrame containing plugin APIs of the native feature runtime engine.

12. The computer-implemented method of claim 11 wherein the preview page comprises a preview window having selectable form factor and orientation.

13. The computer-implemented method of claim 1 comprising dynamically injecting context to a selected plugin API used by the project application during previewing.

14. The computer-implemented method of claim 1 comprising packaging and deploying the project application when completed.

15. An integrated development environment (IDE) for developing an application, the IDE comprising:
a preview module for previewing a project application in a browser on an end-user device running the IDE;
a native feature runtime engine, wherein the native feature runtime engine includes,
an application program interface (API) unit comprising plugin APIs of a mobile device,
an implementation unit, the implementation unit comprises browser implementations of the plugin APIs in JavaScript, wherein the browser implementations enable the application to be previewed in the IDE running in the browser, and
a proxy unit for selecting a selected browser implementation of a called plugin API used by the project application when previewing the project application in the IDE using the browser; and
wherein the native feature runtime engine is invoked when the preview module is initiated to preview the project application.

16. The IDE of claim 15 comprising a user interface (UI) module for facilitating navigation of the IDE by a user, wherein the IDE includes a dynamic injection setting for dynamically injecting context during previewing of the project application.

17. The IDE of claim 15 wherein plugin APIs comprises Cordova plugins.

18. A computer usable medium having a computer readable program code tangibly embodied therein, the computer readable program code adapted to be executed by a processor to implement a method for developing an application comprising:
developing a project application using a web integrated development environment (IDE) with a preview function via a browser, wherein the application includes a hybrid application using native features of a mobile device;
selecting the preview function for previewing the application in the IDE; and
in response to the selecting the preview function,
invoking a native feature runtime engine, wherein the native feature runtime engine comprises plugin application program interfaces (APIs) of the mobile device, and
running the project application in the browser, wherein the project application has access to local resources through browser implementation of plugin APIs provided by the native feature runtime engine.

19. The computer usable medium of claim 18 wherein the native feature runtime engine comprises:
an API unit including the plugin APIs of the mobile device;
an implementation unit including the browser implementations of the plugin APIs, wherein the browser implementations are implemented in JavaScript, wherein the browser implementations enable the application to be previewed in the IDE running in the browser; and
a proxy unit for selecting a browser implementation of a called plugin API used by the project application when previewing the project application in the IDE using the browser.

20. The computer usable medium of claim 19 wherein the native feature runtime engine further comprises a context injection setting for dynamically injecting context to the selected browser implementation of the called plugin API if the context injection setting in an IDE user interface (UI) is selected by a user when previewing the project application.
